(19) United States
(12) Patent Application Publication
(10) Pub. No.: US 2017/0219195 A1
(43) Pub. Date: Aug. 3, 2017

(54) LED HOLDER FOR HOLDING AN LED MODULE

(71) Applicant: OSRAM GmbH, Munich (DE)

(72) Inventors: Luca BORDIN, Munich (DE); Arnulf RUPP, Oberhaching (DE)

(21) Appl. No.: 15/500,940

(22) PCT Filed: Aug. 10, 2015
(86) PCT No.: PCT/EP2015/068391

§ 371 Date: Feb. 1, 2017

(30) Foreign Application Priority Data
Aug. 12, 2014 (DE) 10 2014 215 985.7

(51) Int. Cl. F21V 23/06; F21V 7/22; F21V 29/503; F21V 17/16; F21V 29/70

(52) U.S. Cl. CPC F21V 23/06; F21V 17/16; F21V 29/70; F21V 29/503; F21V 7/22; F21Y 2115/10

(57) ABSTRACT

An LED holder for holding an LED module includes a leadframe, which is populated with electrical and/or electronic components for operating the LED module, wherein the leadframe is at least partially enclosed by potting material, and includes at least two exposed first contact regions for electrically contacting the LED module and at least two exposed second contact regions for electrical contacting.

### RELATED APPLICATIONS

The present application is a national stage entry according to 35 U.S.C. §371 of PCT application No. PCT/EP2015/068391 filed on Aug. 10, 2015, which claims priority from German application No. 10 2014 215 985.7 filed on Aug. 12, 2014, and is incorporated herein by reference in its entirety.

### TECHNICAL FIELD

The present disclosure relates to an LED holder for holding an LED module, which includes a leadframe. The present disclosure also relates to a light generating device, including at least one LED holder, on which at least one LED module is arranged, which LED module is populated or equipped with at least one LED.

The present disclosure furthermore relates to a method for producing an LED holder. The present disclosure additionally relates to a method for providing a light generating device. The present disclosure is applicable in particular to LED spotlights and LED headlights.

### BACKGROUND

LED light generators (so-called “light engines”) are known, in which multiple LEDs and a control or driver electronics unit, optionally having sensors, are arranged on a common circuit board and at least the driver electronics unit is covered by a housing. The LEDs can be populated as LED chips in the so-called chip-on-board (“CoB”) on the circuit board. These LED light generators are comparatively complex to design, in particular in the event of a redesign, and are also costly to produce.

An LED light generator is also known, in which the LED module has a separate housing, but no driver electronics unit. The LED module rather has to be externally connected to a driver electronics unit of the LED light generator, for example, via suitable cables. The restricted or absent functionality is disadvantageous in this case, in particular also as a result of absent sensors such as temperature sensors. An LED module is understood in particular as a unit of multiple interconnected LEDs.

### SUMMARY

It is the object of the present disclosure to at least partially overcome the disadvantages of the prior art and in particular to provide a cost-effectively producible LED light generator having a high level of functionality.

This object is achieved according to the features of the independent claims. Preferred embodiments can be inferred from the dependent claims in particular.

The object is achieved by a holder (referred to hereafter as an “LED holder” without restricting the generality) for holding an LED module, including a leadframe, which is populated with electrical and/or electronic components for operating the LED module, wherein the leadframe is at least partially enclosed by potting material and includes at least two exposed first contact regions for electrically contacting the LED module and at least two exposed second contact regions for electrical contacting.

Such an LED holder has the advantage that, due to the potting material, the shape of the leadframe (sometimes also referred to as a stamped lattice) can also be maintained under external mechanical stress. Depending on the selected elasticity and/or rigidity of the potting material, the LED holder may be elastically yielding or practically rigid. In addition, the potting material protects the leadframe particularly effectively from corrosion and abrasion. In addition, an electrically insulating potting material ensures safe handling of the LED holder. Furthermore, potting material is applicable particularly cost-effectively to the leadframe. The potting material may have a high thermal conductivity.

In general, such an LED holder additionally enables a usage of particularly simple production methods. Thus, the leadframe enables particularly cost-effective provision of electrical wiring. Moreover, cost-effective materials can be used for the potting material, for example, plastic such as silicone, polybutylene terephthalate (abbreviation PBT), polycaprolactam (abbreviation PA6), or polycarbonate (abbreviation PC), etc. A separate holding element can advantageously be omitted, because the LED holder is self-supporting.

Due to the fact that the LED module and the LED holder are produced independently of one another and then brought together, an optical property can be easily adapted by replacing a typical cost-effective LED module. In particular, LED modules having different LEDs with respect to color, power, and/or number, for example, and/or having arbitrary sensors, for example, temperature sensors, can be added to the holder or replaced in a simple manner. The presence of a temperature sensor enables particularly efficient heat management, for example.

Electrical components may include, for example, resistors, capacitors, coils, diodes, oscillators, etc. The electrical components may be surface-mounted components (surface-mounted devices; SMDs) for simple populating. Electronic components may include, for example, integrated components such as microcontrollers, FPGAs, ASICs, etc. Integrated components may in particular also be provided as bare chips or “bare dies”. However, the leadframe may also be equipped, for example, with an antenna, etc., for example, for wireless communication. The electrical and/or electronic components may in particular represent a driver electronics unit or a part thereof.

The potting material may be in particular an injection-moldable potting material. If the potting material has been applied by means of an injection molding method, it may also be referred to as “extrusion coating”.

The second contact regions are used for different electrical contacting than that of the LED module, in particular for contacting a connecting element such as a power supply line and/or a data line. The contacting may be detachable or non-detachable.

The second contact regions are arranged in particular on a lateral edge of the leadframe or the LED holder for simple contacting.

The construction of the leadframe or conductor frame is not restricted and may consist, for example, of a copper alloy, steel, brass, etc. and may be coated, for example, using nickel, silver, tin, etc.

In one embodiment, the LED holder has at least one opening for inserting or feeding through a respective LED module, in particular a central opening. A shape of the opening is arbitrary and may be circular or polygonal, for example. It may correspond to a shape and size of a light emission region of the LED module. The opening may in particular include an opening in the potting material, which is congruent with an opening in the leadframe. The opening in the potting material may be somewhat smaller than the opening in the leadframe, so that a protrusion of the potting material in the opening into the leadframe can be used as a support or stop and/or for accurate positioning of the LED module.

The LED holder may include a ring-shaped outer contour in a top view of the opening, in particular if the leadframe has three second contact regions. The ring-shaped outer contour may be in particular an outer contour in the form of a circular ring or an oval outer contour.

In one refinement, the leadframe and/or the LED holder has an n-side outer contour in a top view of the opening corresponding to a number n>=3, in particular n=3, of second contact regions. One of the contact regions may be used, for example, to read out sensor data of a temperature sensor.

The potting material, in particular for the case in which a second contact region of the leadframe has a cable clip (“wire trap”), may be formed there having a holding mechanism for holding a line in the cable clip, for example, a catch tab. The holding mechanism may be, for example, a release mechanism for releasing the line which is otherwise fixed thereon.

The potting material may be designed to be at least partially reflective for increased light yield and/or for reduced light loss. This applies in particular if the LED holder is provided to be used in a reflective environment. The reflective property can be achieved, for example, by a coating which reflects in a diffuse or mirrored manner.

The LED holder may in particular have holding tabs for its fastening (for example, to a heat sink), which have, for example, holes for feeding through fastening elements, for example, screw holes. For this purpose, the LED holder may alternatively or additionally have fastening elements at another point, for example, catch pins, clamps, etc. The fastening elements may be formed in particular by appropriately shaped fastening regions of the potting material.

The LED holder may furthermore have fastening elements or fastening regions, for example, hooks, clamps, or catch tabs, which are used for fastening the at least one LED module. This may facilitate installation of the LED holder equipped with the LED module.

In a further embodiment, at least one second contact region is designed as a cable clip.

This enables particularly simple and secure contacting of single cables, in particular wires.

In still another embodiment, at least one second contact region is designed as a plug terminal (plug, socket, etc.). More complex terminals can thus also be used, for example, multipole terminals, for example, for connecting a coaxial cable or a bus-capable plug element (for example, a USB plug, a FireWire plug, a Lightning plug, an ethernet cable (for example, designed as a power-over-ethernet cable), etc.). The element (coaxial cable, bus-capable plug element, data cable, etc.) connectable to the at least one second contact region may also be fastened thereon in a nondetachable manner, for example, soldered on.

For particularly simple production, the second contact regions can be provided by reshaping a leadframe basic shape, for example, by bending of predefined regions of the leadframe basic shape. However, they can also be provided, for example, by a nondetachable fastening of a previously produced contact element to the leadframe before the potting thereof, in particular extrusion coating. The nondetachable fastening can be produced, for example, by welding, in particular laser welding. The leadframe basic shape may be a quasi-endless leadframe strip in particular.

Advantageously, at least one, all second contact regions may be designed such that a line connected thereon is led into the contact region or away therefrom tangentially in relation to an outer edge or outer side of the leadframe, i.e., in the case of a linear edge, in parallel thereto, and in the case of a curved edge, for example, in the case of a ring-shaped leadframe, tangentially, i.e., perpendicularly in relation to a radial direction, in particular also in parallel to the installation surface of the leadframe in all cases. A space-saving arrangement is thus achieved, in which small radii of curvature of the terminal lines can be avoided.

In a further embodiment, at least one first contact region is designed as a springy contact tab. The LED module, in particular contact fields thereof, may be pressed thereon, which enables particularly simple contacting. The at least one springy contact tab may extend in particular into the opening of the LED holder.

Such contact tabs enable pressing of the LED module onto a support in a particularly simple manner as a result of a restoring force of the contact tabs.

In one refinement, the LED module is housed in the LED holder.

The object is also achieved by a light generating device, including at least one LED holder as described above, on which at least one LED module is arranged, in particular fastened. The leadframe of the LED holder is electrically connected via its first contact regions to the LED module.

The LED module is populated with at least one light-emitting diode (LED). If multiple light-emitting diodes are provided, they can illuminate in the same color or in different colors. A color can be monochromatic (for example, red, green, blue, etc.) or multi-chromatic (for example, white). The light emitted by the at least one light-emitting diode can also be an infrared light (IR-LED) or an ultraviolet light (UV-LED). Multiple light-emitting diodes can generate a mixed light; for example, a white mixed light. The at least one light-emitting diode can contain at least one wavelength-converting phosphor (conversion LED). The phosphor can alternatively or additionally be arranged remotely from the light-emitting diode (“remote phosphor”). The at least one light-emitting diode can be provided in the form of at least one individually housed light-emitting diode or in the form of at least one LED chip. Multiple LED chips can be mounted on a common substrate (“submount”). The at least one light-emitting diode can be equipped with at least one separate and/or common optical unit for beam guiding, for example, at least one

Fresnel lens, collimator, etc. Additionally or alternatively to inorganic light-emitting diodes, for example, based on InGaN or AlInGaP, in general organic LEDs (OLEDs, for example, polymer OLEDs) are also usable.

The light generating device may be in particular a light generator or “light engine”.

In one embodiment, the LED module is a CoB module. A substrate, in particular a printed circuit board, may be populated with at least one LED chip therein. Furthermore, at least two contact fields for contacting the first contact region of the LED holder may be provided on the substrate.

The at least one LED, in particular an LED chip, may be potted, in particular using a phosphor-containing, light-transmissive potting material, for example, epoxy resin or silicone.

The LED module may be an electronics-free carrier, which enables a particularly simple and cost-effective embodiment.

The LED module may alternatively include a part of an electronics unit for operating the at least one LED of the LED module (“driver electronics unit”).

In still another embodiment, the LED module includes at least one sensor for the thermal management of the LEDs or the LED module, in particular a temperature sensor, and/or at least one coding unit. The temperature sensor may be an NTC resistor, for example.

However, the LED module may also, for example, include at least one color sensor for particularly accurate setting of a colorimetric locus of the light emitted by the LED module. The LED module may also include, for example, a brightness sensor for the brightness regulation.

The LED module may alternatively or additionally include at least one component as a or as part of a coding unit, which is used for its identification by the LED carrier or the electronics unit arranged thereon, for example, a resistor having a value determined for the type of the LED module. The resistor may be, for example, a current-limiting or current-setting resistor, by which, for example, with a fixedly predefined supply voltage, the operating current for the LEDs of the specific LED module is settable.

The light generating device may be fastened on a heat sink in such a manner that the LED holder presses the at least one LED module onto the heat sink. In particular, the LED module may press with its front side on the associated first contact regions and rest with its rear side on the heat sink. The LED holder may also rest with its rear side or with the rear side of the extrusion-coated leadframe on the heat sink. The contact pressure force, by which the LED holder presses the LED module onto the heat sink, may result in particular due to an elastic restoring force of the first contact regions, which are bent by the contact pressure of the LED module.

The heat sink may be a component of the light generating device. Instead of the heat sink, however, the light generating device may also be fastened on any other suitable underlay.

Direct, effective cooling of the components housed in the housing may thus be achieved, for example, by placing the LED holder equipped with at least one LED module having its open rear side on a heat sink. For example, a rear side of the LED module, which faces away from the LEDs, can thus be seated directly and not only via a rear housing wall on the heat sink and can thus be cooled.

The light generating device may furthermore include a housing, which covers at least a part of the LED holder. The housing may cover in particular a part of the LED holder which includes exposed (non-potted) electrical and/or electronic components.

The housing may have in particular a light-transmissive opening, in particular a central light-transmissive opening.

The object is furthermore achieved by a method for producing an LED holder as described above.

The method may include in particular at least the following steps for this purpose: providing a leadframe by adapting a leadframe basic shape; populating the leadframe with electrical and/or electronic components; and extrusion coating the leadframe using a potting material so that at least two first contact regions for electrically contacting the LED module and at least two second contact regions are exposed.

The steps of populating and extrusion coating may be carried out in this sequence or in the reverse sequence. If the populating is carried out before the extrusion coating, all electrical and/or electronic components may be extrusion coated, only a part of the electrical and/or electronic components may be extrusion coated, or none of the electrical and/or electronic components may be extrusion coated. If the extrusion coating is carried out before the populating, in particular also contact regions of the leadframe for contacting the at least one electrical and/or electronic component are kept free during the extrusion coating and the first and the second contact regions are kept free.

The method results in the same advantages as the LED holder and can be designed similarly.

In particular the leadframe basic shape can be produced cost-effectively in mass production, for example, as a quasi-endless strip.

The adaptation of the leadframe basic shape, so that it is suitable for use in the LED holder, may, for example, include a partial step of isolating the leadframe from the leadframe basic shape along a desired outer contour of the leadframe and/or severing conductor tracks to produce a desired wiring arrangement of the leadframe. The severing may be performed, for example by means of stamping, laser cutting, etc. The adaptation may also include bending over to produce, for example, a cable clip and/or a contact tab or contact spring.

An additional step may include fixed terminal by means of a terminal element, for example, a previously produced cable clip or a plug connector, to the previously isolated leadframe.

It is also a possible step that a step of severing at least one conductor track of the leadframe follows the extrusion coating of the leadframe using the potting material. The cable routing of the leadframe can thus be designed in even more manifold ways.

In particular, the leadframe can thus be divided into two or more separate parts, without falling apart, because the parts are still mechanically held together by the extrusion coating. This enables, for example, the application of different voltages to the different parts. At least one of the parts, in particular at least two of the parts, may be able to be contacted by a contact tab or contact spring.

The method may also include a step of testing the LED holder.

A method for providing a light generating device, in particular a light generator, may include the following steps in particular: (i) placing at least one LED module on a rear side of the LED holder so that an electrical contact results via the first contact regions between them, and (ii) placing the rear side of the LED holder with the LED module on an underlay so that the LED holder presses the LED module onto the underlay.

### BRIEF DESCRIPTION OF THE DRAWINGS

The above-described properties, features, and advantages of this present disclosure and the manner in which they are achieved will become clearer and more comprehensible in conjunction with the following schematic description of exemplary embodiments, which are explained in greater detail in conjunction with the drawings.

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a top view in a sectional illustration of an LED holder according to a first embodiment;

FIG. 2 shows a top view in a sectional illustration of an LED holder according to a second embodiment; and

FIG. 3 shows a top view in a sectional illustration of an LED holder according to a third embodiment.

### DETAILED DESCRIPTION

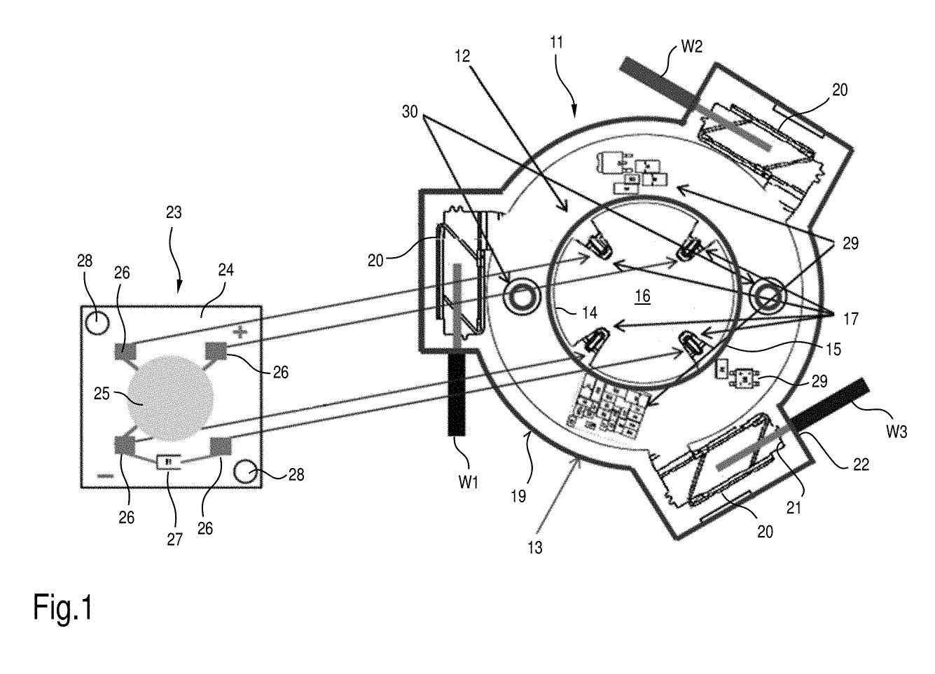

FIG. 1 shows an LED holder 11 according to a first embodiment having a leadframe 12 and an extrusion coating 13, which at least substantially encloses the leadframe 12, made of an injection-moldable plastic. The leadframe 12 and its extrusion coating 13 and therefore also the LED holder 11 have a ring-shaped basic shape. The leadframe 12 has a circular central recess 14 for this purpose, which is arranged concentrically in relation to a circular central recess 15 of the extrusion coating 13. First contact regions in the form of springy contact tabs 17 protrude into the opening 16 delimited by the recesses 14, 15. The contact tabs 17 are distributed equidistantly here around the circumference of the opening 16 or the recess 14 of the leadframe 12. The contact tabs 17 may have been produced in particular by a stamping and/or reshaping process from a leadframe basic shape.

The leadframe 12 has a fundamentally circular outer contour 19, wherein a second contact region in the form of a cable clip (“wire trap”) 20 is attached on the outside at each of three circumferential equidistantly distributed points. The cable clips 20 may also have been produced, for example, by a stamping and/or reshaping process from a leadframe basic shape. It may alternatively have been produced separately and then non-detachably connected to the remaining leadframe 12, for example, by laser welding, soldering on, etc.

The cable clips 20 are externally extrusion coated by the extrusion coating 13 so that it is possible to insert or lead connecting cables W1, W2, W3 into or out of the cable clips 20.

For this purpose, the extrusion coating 13 may there include, for example, an insertion hole 22 which is congruent with an insertion opening 21 of the cable clips 20. The connecting cables W1, W2, W3 may be fixedly connected to the cable clips 20, for example, by soldering or welding, or may be detachably held therein, for example, by clamping or detachable latching. The connecting cables W1, W2, W3 can be used for the supply with electrical power and/or for data transmission.

The leadframe 12 is populated with electrical and/or electronic components 29, which are provided for operating an LED module 23 to be inserted into the LED holder 11. In other words, a driver electronics unit, which includes the electrical and/or electronic components 29, is at least partially integrated into the LED carrier 11. The electrical and/or electronic components 29 may in particular not be enclosed or extrusion coated by the extrusion coating 13, which improves the heat dissipation thereof.

An LED module 23 is provided for holding by the LED holder 11. The LED module 23 includes a substrate 24, for example, a printed circuit board or a ceramic substrate provided with conductor tracks. LEDs (not shown) are arranged centrally on a front side of the substrate 24, which are covered by a phosphor-containing potting material 25, for example, made of silicone. Outside the potting material 25, multiple, four here, contact fields 26 are provided on the front side on the substrate 24. These contact fields are electrically connected via conductor tracks to the LEDs for the operation thereof. Two of the contact fields 26 are also connected to the two terminals of a temperature sensor, for example, an NTC resistor 27. For example, a heat management of the LED chip can be enabled by means of the NTC resistor 27.

Additionally or alternatively to the NTC sensor 27, for example, a coding element in the form, for example, of a coding resistor can also be provided for identifying the LED module 23. Overall, the more than double electrical contacting of the LED module 23 enables independent operation of multiple strands of LEDs, for example, of different colors, for example, red, green, and blue, respectively. The LEDs may be LED chips (sometimes also referred to as unhoused LED chips), so that the LED module 23 is designed as a CoB (“chip-on-board”) module. The substrate 24 has matching conductor tracks, etc. for this purpose. A further application is that a center tap is connected to a contact tab for powering the electronics unit on the LED holder 11.

To marry LED holder 11 and LED module 23, the LED module 23 is inserted with its front side into the recess 14 of the leadframe so that the potting material 25 containing the phosphor protrudes into or through the recess 14, while the contact fields are pressed against the contact tabs 17, which are thus elastically bent. The contact tabs 17 are thus used for the electrical contacting of corresponding contact fields 26 of the LED module 23 and for generating a contact pressure force on the LED module 23 in the reverse direction. The substrate 24 of the LED module 23 furthermore has two mounting holes 28 for fastening the LED module 23 on the LED carrier 11, for example, by means of hot caulking, crimping, etc.

The LED holder 11 and the LED module 23 together form a light generating device, in particular a light engine or light generator 11, 23. The light generator 11, 23 can be placed with its rear side on an underlay and fastened thereon. The underlay may be a heat sink (not shown). For fastening the LED holder 11, mounting holes 30 are provided in the leadframe 12 and in the extrusion coating 13, to fasten the LED holder 11 by means of a screw terminal, for example.

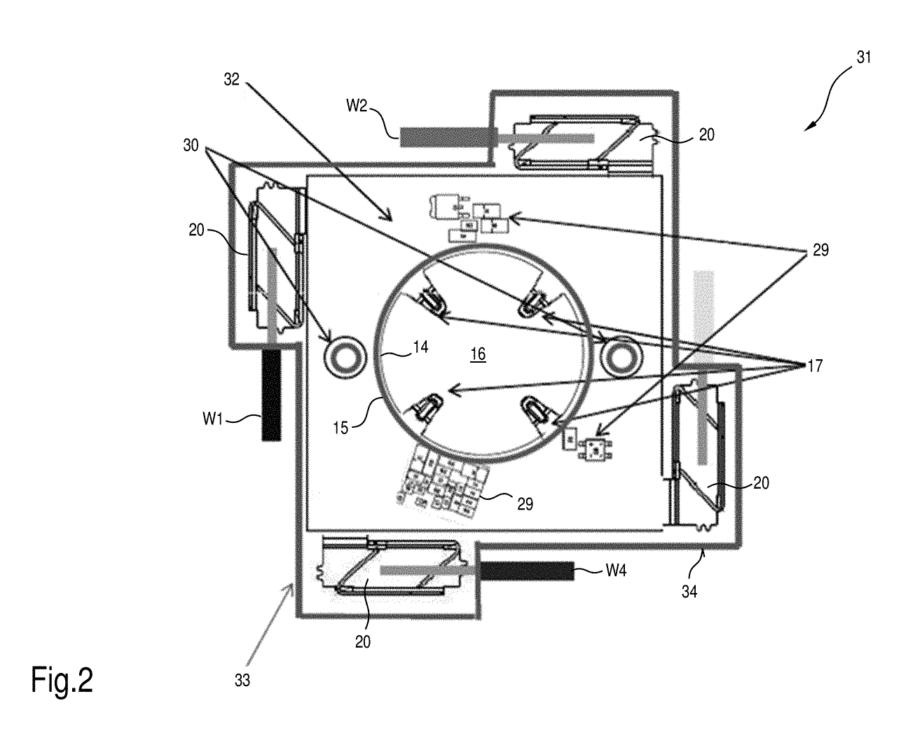

FIG. 2 shows a top view in a sectional illustration of an LED holder 31 according to a second embodiment. The LED holder 31 is constructed similarly to the LED holder 11. In contrast to the LED holder 11, however, the LED holder 31 has a leadframe 32 having an extrusion coating 33 having a, in a top view four-sided, in particular square outer contour 34 in each case. An extrusion coated cable clip 20 adjoins the exterior on each of the four straight sides of the outer contour 34. One of four wires or cables W1 to W4 is inserted into each of the cable clips 20.

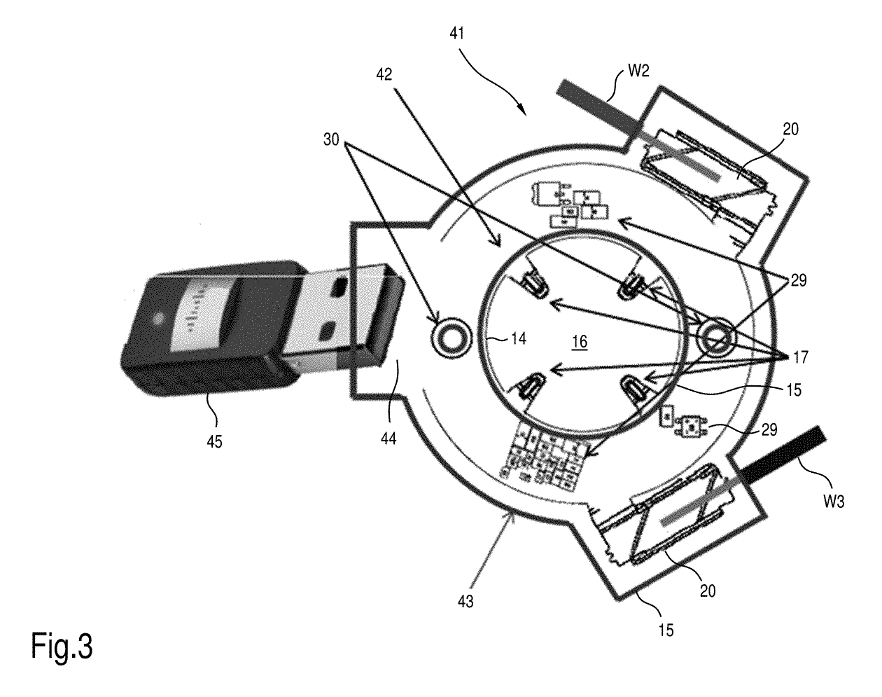

FIG. 3 shows a top view in a sectional illustration of an LED holder 41 according to a third embodiment. The LED holder 41 is constructed similarly to the LED holder 11, but differs, however, in that a second extrusion-coated contact region of the associated LED frame 43 is designed as an electrical plug terminal. This plug terminal is designed here as a bus-type terminal in the form of a USB terminal 44. For example, a USB device 45 may be connected to the USB terminal 44, for example, a USB memory stick, a wireless transceiver, for example, for retrofitting as a Wi-Fi and/or Bluetooth device, or also a USB cable for wired communication.

Although the present disclosure was illustrated and described in greater detail by the embodiments shown, the present disclosure is not thus restricted thereto and other variations can be derived therefrom by a person skilled in the art, without leaving the scope of protection of the present disclosure.

The LED module may also include a part (but not all) of the electrical and/or electronic components of a driver circuit.

In general, “a”, “one”, etc. can be understood as a single or a multiple, in particular in the meaning of “at least one” or “one or more”, etc., as long as this is not explicitly precluded, for example, by the expression “precisely one” etc.

A numeric specification can also include precisely the specified number and also a routine tolerance range, as long as this is not explicitly precluded.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An LED holder for holding an LED module, comprising:
a leadframe, which is populated with electrical and/or electronic components for operating the LED module,
wherein the leadframe is at least partially enclosed by potting material; and
at least two exposed first contact regions for electrically contacting the LED module and at least two exposed second contact regions for electrical contacting.

2. The LED holder as claimed in claim 1, which has a central opening for feeding through the LED module.

3. The LED holder as claimed in claim 1, wherein at least one second contact region is designed as a cable clip.

4. The LED holder as claimed in claim 1, wherein at least one second contact region is designed as a plug terminal.

5. The LED holder as claimed in claim 1, wherein the second contact regions have been produced by reshaping from a leadframe basic body.

6. The LED holder as claimed in claim 1, wherein the second contact regions have been produced separately and then fixedly connected to the leadframe.

7. The LED holder as claimed in claim 1, wherein at least one first contact region is designed as a springy contact tab.

8. The LED holder as claimed in claim 1, wherein the LED holder is configured for its rear fastening on an underlay.

9. A light generating device, comprising at least one LED holder, on which at least one LED module is arranged, wherein the LED holder comprises a leadframe, which is populated with electrical and/or electronic components for operating the LED module, wherein the leadframe is at least partially enclosed by potting material, and at least two exposed first contact regions for electrically contacting the LED module and at least two exposed second contact regions for electrical contacting.

10. The light generating device as claimed in claim 9, wherein the LED module is a CoB module.

11. The light generating device as claimed in claim 9, wherein the LED module is an electronics-free carrier.

12. The light generating device as claimed in claim 9, wherein the LED module comprises a part of an electronics unit for operating the at least one LED of the LED module.

13. The light generating device as claimed in claim 9, wherein the LED module comprises at least one temperature sensor and/or at least one coding unit.

14. The light generating device as claimed in claim 13, wherein the coding unit has a current limiting resistor.

15. A method for producing an LED holder, the LED holder comprising a leadframe, which is populated with electrical and/or electronic components for operating the LED module, wherein the leadframe is at least partially enclosed by potting material, and at least two exposed first contact regions for electrically contacting the LED module and at least two exposed second contact regions for electrical contacting, the method comprising:
providing the leadframe by adapting a leadframe basic shape,
populating the leadframe with electrical and/or electronic components, and
extrusion coating the leadframe using the potting material so that at least two first contact regions for electrically contacting the LED module and at least two second contact regions are exposed.
